(19) United States
(12) Patent Application Publication
(10) Pub. No.: US 2017/0036265 A1
(43) Pub. Date: Feb. 9, 2017

(54) CONTINUOUS CASTING METHOD FOR INGOTS OBTAINED FROM TITANIUM OR TITANIUM ALLOY

(71) Applicant: KABUSHIKI KAISHA KOBE SEIKO SHO (KOBE STEEL, LTD.), Kobe-shi (JP)

(72) Inventors: Eisuke KUROSAWA, Hyogo (JP); Takehiro NAKAOKA, Hyogo (JP); Kazuyuki TSUTSUMI, Hyogo (JP); Hideto OYAMA, Hyogo (JP); Hidetaka KANAHASHI, Hyogo (JP)

(73) Assignee: KABUSHIKI KAISHA KOBE SEIKO SHO (KOBE STEEL, LTD.), Kobe-shi (JP)

(21) Appl. No.: 15/296,559

(22) Filed: Oct. 18, 2016

Related U.S. Application Data
(62) Division of application No. 14/895,750, filed on Dec. 3, 2015.

(30) Foreign Application Priority Data
Jun. 27, 2013 (JP) 2013-135205

(51) Int. Cl. B22D 11/00; B22D 11/14; H05H 1/44; B22D 7/00; B22D 9/00; B22D 11/041; B22D 11/12

(52) U.S. Cl. CPC B22D 11/001; B22D 11/041; B22D 11/141; B22D 11/1213; B22D 7/005; B22D 9/006; H05H 1/44

(57) ABSTRACT

For continuously casting an ingot of titanium or titanium alloy, molten titanium or titanium alloy is poured into a top opening of a bottomless mold with a circular cross-sectional shape, the solidified molten metal in the mold is pulled downward from the mold, a plurality of plasma torches disposed on an upper side of molten metal in the mold such that their centers are located directly vertically above the molten metal in the mold, are operated to generate plasma arcs that heat the molten metal in the mold, and the plasma torches are moved in a horizontal direction above a melt surface of the molten metal in the mold, along a trajectory located directly vertically above the molten metal in the mold, while keeping a mutual distance between the respective plasma torches such that the plasma torches do not interfere with each other.

### CROSS-REFERENCE TO RELATED APPLICATIONS

The application is a divisional application of U.S. application Ser. No. 14/895,750, filed Dec. 3, 2015, which is a National Stage application of PCT/JP2014/065517, filed on Jun. 11, 2014 which is based upon and claims the benefit of priority from Japanese Patent Application No. 2013-135205, filed Jun. 27, 2013; the entire contents of all of which are incorporated herein by reference.

### FIELD

The present invention relates to a continuous casting method of an ingot formed of titanium or a titanium alloy.

### BACKGROUND ART

In continuous casting of an ingot, titanium or a titanium alloy melted by heating the melt surface by plasma arc melting (PAM) or electron beam melting (EB) is charged into a bottomless mold and pulled out downward while solidifying it.

Patent Document 1 discloses an automatically controlled plasma melting casting method. In the automatically controlled plasma melting casting method, titanium or a titanium alloy is melted by plasma arc in an inert gas atmosphere, charged into a mold, and solidified. Unlike electron beam melting that is performed in vacuum, the plasma arc melting method performed in an inert gas atmosphere described in Patent Document 1 can cast not only pure titanium but also a titanium alloy.

Patent Document 2 discloses an apparatus for melting and continuous casting a high-melting-point metal ingot by an electron beam method. In the melting and continuous casting apparatus descried in Patent Document 2, an ingot is pulled out while rotating its bottom, and among electron beams for irradiation, the melt surface is irradiated while making the density of electron beams incident along the peripheral part of a mold be higher than that in the central part of the mold.

Since the ingot formed of titanium or a titanium alloy is completed as a product through steps of rolling, forging, heat treatment, etc., an ingot having as a large diameter as 800 to 1,200 mm is required for obtaining a product excellent in the mechanical properties such as fatigue strength.

### PRIOR ART LITERATURE

### Patent Document

Patent Document 1: Japanese Patent No. 3077387

Patent Document 2: JP-A-2009-172665

### SUMMARY OF THE INVENTION

### Problems that the Invention is to Solve

However, in the case of continuously casting a round ingot having a large diameter by a plasma arc melting method, a plasma torch has a limited heating range. Therefore, in order to melt titanium or a titanium alloy, the melt surface needs to be entirely heated by moving the torch.

Here, in a method for continuously casting a round ingot of titanium (particularly, a titanium alloy), significant component segregation is caused with an increase in the ingot diameter as described below. An irregularity or flaw generated on the surface of the obtained ingot due to significant component segregation works out to a surface defect in the subsequent rolling or forging step. Therefore, in the continuous casting of a large-diameter ingot formed of titanium or a titanium alloy, the component segregation must be reduced to establish an improvement of the casting surface.

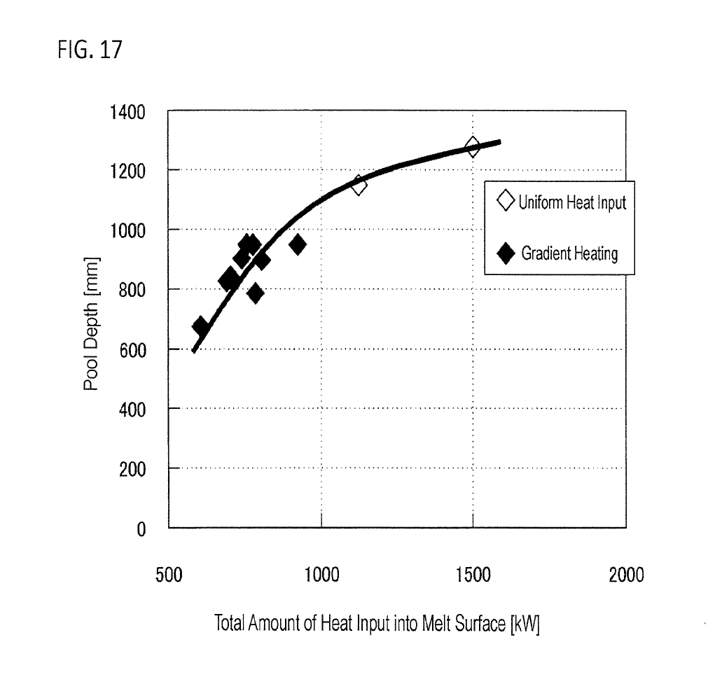

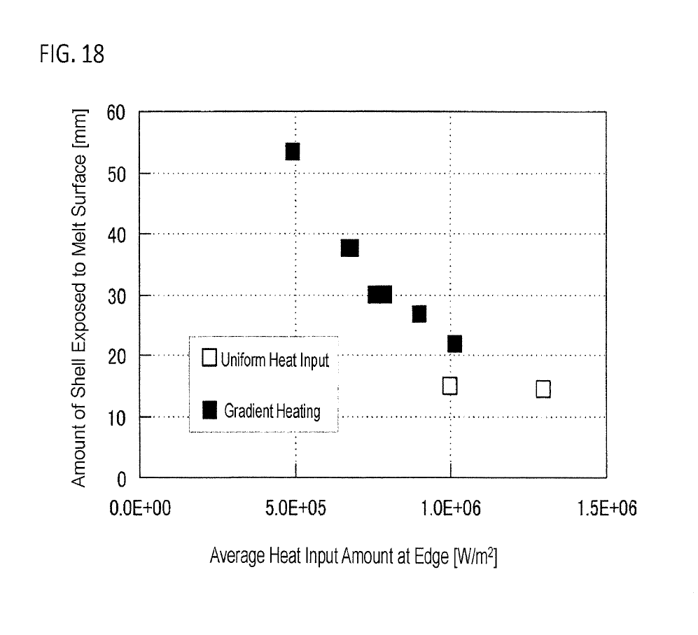

The component segregation that becomes significant with an increase in the diameter of an ingot is described below. In order to make the diameter of a round ingot large, as the diameter of the round ingot is increased, the total amount of heat required to be input into the melt surface during continuous casting becomes larger. FIG. 17 shows the relationship between the total amount of heat input into the melt surface and the pool depth of a molten metal pool formed inside of a mold when uniform heat input or gradient heat input is performed in a continuous casting apparatus. As shown in FIG. 17, when the total amount of heat input into the melt surface is increased, the depth at the center of the molten metal pool formed becomes deep. When the depth at the center of the molten metal pool formed becomes deep, component segregation becomes significant, and the heat input amount in the vicinity of the edge of a round mold becomes excessively small. Then, as shown in FIG. 18 showing the relationship between the average heat input amount at the edge and the amount of a shell exposed to the melt surface when uniform heat input or gradient heat input is preformed in a continuous casting apparatus, the amount of a shell exposed to the melt surface is increased, and the growth of an initial solidified shell is accelerated. As a result, the surface profile of the ingot is deteriorated, making the withdrawal casting difficult depending on the case.

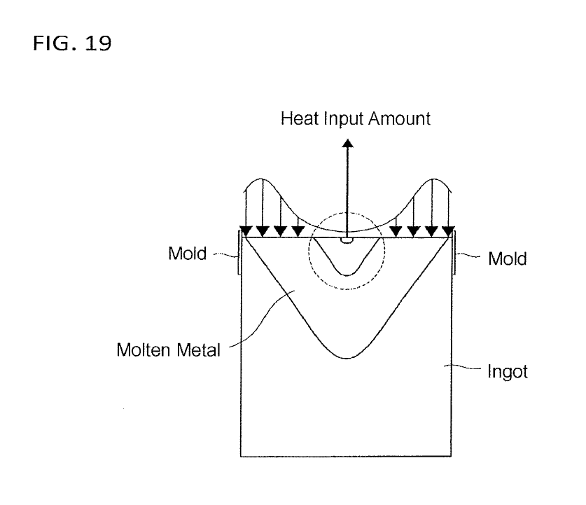

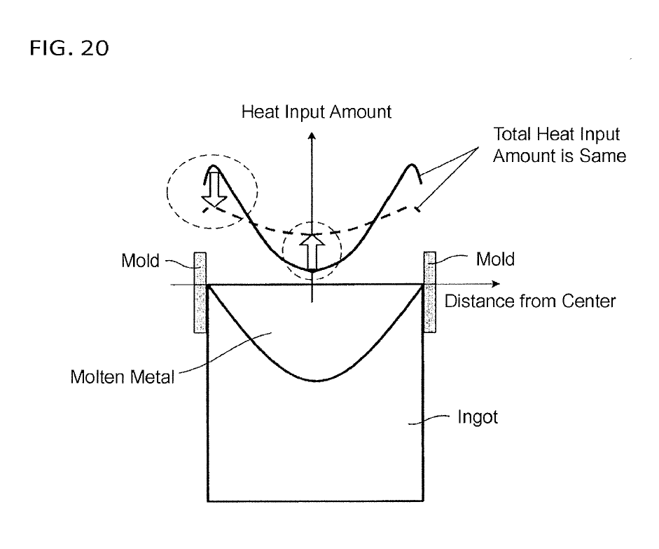

On the other hand, in the case of performing gradient heating so as to input a large amount of heat in the vicinity of the edge of a round mold and input a small amount of heat near the central part, it is considered that not only the total amount of heat input into the melt surface is decreased and the depth at the center of the molten metal pool is reduced but also the growth of an initial solidified shell can be suppressed. However, in this case, the following problems arise. FIG. 19 is a cross-sectional view showing the relationship between the average amount of heat input into the melt surface and the pool depth of a molten metal pool formed inside of a mold in a continuous casting apparatus when the total heat input amount is reduced and the heat input amount is concentrated in the vicinity of the edge. As shown in FIG. 19, when the total heat input amount is decreased and the heat input amount is too much concentrated in the vicinity of the edge part, the heat input amount lacks near the central part, causing a problem that the portion near the central part (the portion surrounded by a dashed line shown in FIG. 19) is solidified. FIG. 20 is a cross-sectional view showing the relationship between the average amount of heat input into the melt surface and the pool depth of a molten metal pool formed inside of a mold in a continuous casting apparatus when the total heat input amount is the same but the heat input amount near the central part is increased. As shown in FIG. 20, when the total heat input amount is the same and the heat input amount near the central part (the portion surrounded by a dashed line shown in FIG. 20) is increased, the heat input amount in the vicinity of the edge (the portion surrounded by a dashed line shown in FIG. 20) is decreased, and the growth of an initial solidified shell is accelerated.

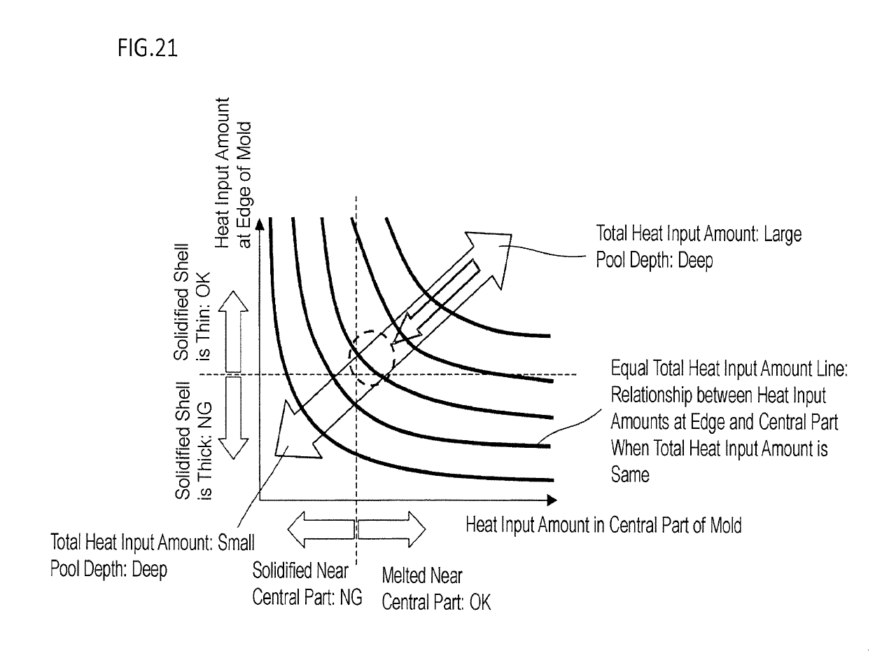

FIG. 21 shows the relationship between the heat input amount in the vicinity of the edge of a mold and the heat input amount near the central part of the mold in a continuous casting apparatus when, as described above, the total heat input amount is the same. As shown in FIG. 21, in a continuous casting apparatus of an ingot formed of titanium or a titanium alloy, the total heat input amount, the heat input amount in the vicinity of the edge of a mold, and the heat input amount near the central part of the mold (the range surrounded by a dashed line shown in FIG. 21) are preferably determined so as to suppress the growth of an initial solidified shell and reduce the total heat input amount as much as possible within a region where solidification near the central part can be avoided.

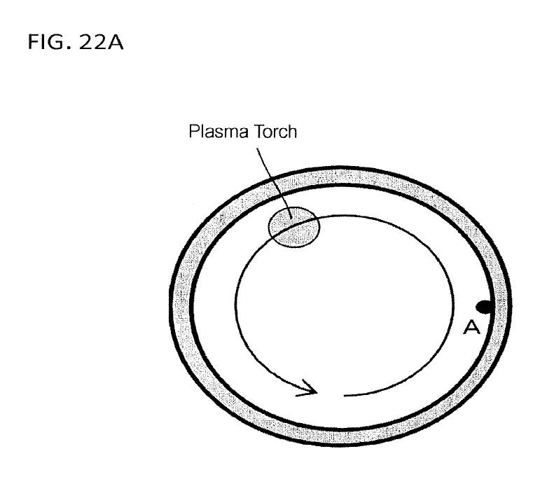

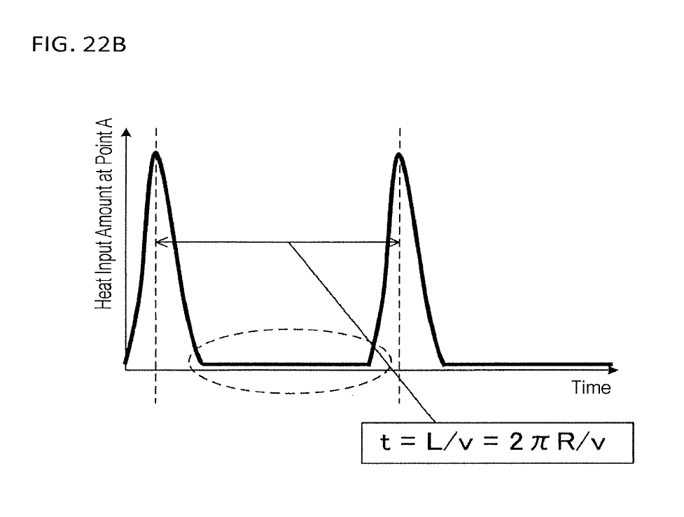

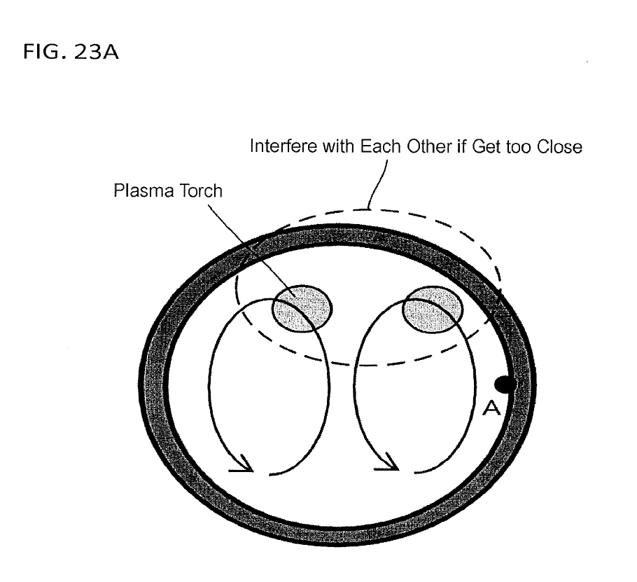

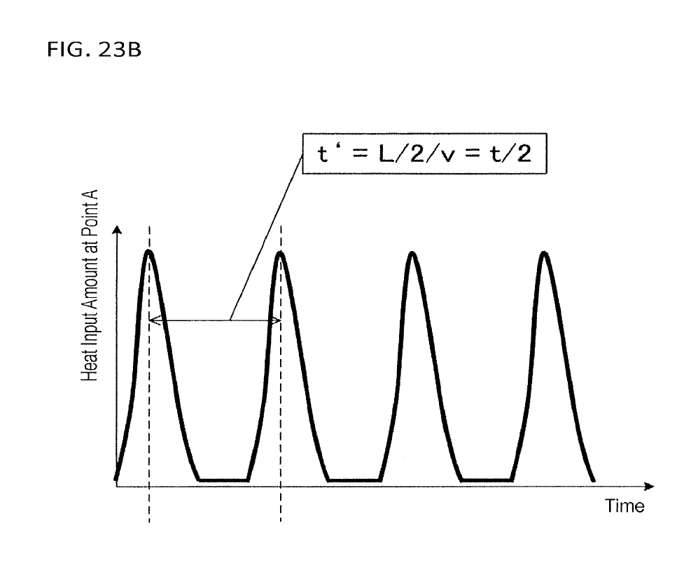

In addition, in the case of continuously casting an ingot having as a large diameter as φ800 to 1,200 mm, if only one plasma torch is used for heating the melt surface as shown in FIG. 22A, the torch must move a long distance. In turn, the time from when the plasma torch departs from a predetermined portion (here, the point A) till when it returns to the portion becomes long as shown in FIG. 22B that is a graph of the history of heat input at the point A, and during that time (the range surrounded by a dashed line shown in FIG. 22B), the ingot temperature is significantly reduced. By using a plurality of plasma torches (here, two torches) for heating the melt surface as shown in FIG. 23A, the time for which the plasma torch is separated from the point is shortened as shown in FIG. 23B that is a graph of the history of heat input at the point A, and the reduction in the ingot temperature can be suppressed. However, in the case of using a plurality of plasma torches, if each plasma torch gets too close to every other plasma torch during movement, for example, these plasma torches interfere with each other as shown in FIG. 23A, and the life of the plasma torch may be shortened. Therefore, it is necessary to establish a torch movement pattern enabling a certain distance to be kept between a plurality of plasma torches.

A problem to be solved by the present invention is to provide a continuous casting method of an ingot formed of titanium or a titanium alloy, where an ingot having a good casting face is produced by reducing the component segregation and the life of a plasma torch can be extended by causing no interference of plasma torches with each other.

### Means for Solving the Problems

In order to solve the above problems, the continuous casting method of an ingot formed of titanium or a titanium alloy in the present invention, which continuously casts the ingot formed of titanium or a titanium alloy, includes pouring molten titanium or titanium alloy into a top opening of a bottomless mold with a circular cross-sectional shape, pulling the solidified molten metal in the mold downward from the mold, operating a plurality of plasma torches disposed on an upper side of molten metal in the mold such that their centers are located directly vertically above the molten metal in the mold to generate plasma arcs that heat the molten metal in the mold, and moving the plasma torches in a horizontal direction above a melt surface of the molten metal in the mold, along a trajectory located directly vertically above the molten metal in the mold, while keeping a mutual distance between the respective plasma torches such that the plasma torches do not interfere with each other.

According to this, a plurality of plasma torches are moved while keeping a distance not to allow for interference with each other, whereby the movement distance of each plasma torch can be shortened. As a result, an ingot having a good casting surface can be produced by suppressing the reduction in the ingot temperature and reducing the component segregation, and the life of the plasma torch can be extended by causing no interference of plasma torches with each other.

In the continuous casting method of an ingot formed of titanium or a titanium alloy in the present invention, the number of the plasma torches may be 2, and the plasma torches are moved such that when one plasma torch is located on an upper side in the vicinity of an edge of the mold, the other plasma torch may be located near a central part of the mold.

According to this, two plasma torches are used, so that the movement distance of each plasma torch can be shortened and the reduction in the ingot temperature can be suppressed. In addition, each of two plasma torches is moved to be located either on the upper side in the vicinity of the edge of a mold or on the upper side near the central part of the mold, so that the entire melt surface can be heated while causing no interference of two plasma torches with each other. As a result, not only an ingot having a good casting surface can be produced by reducing the component segregation but also the life of the plasma torch can be extended.

In addition, assuming that a radius of the melt surface is R, the plasma torch may be moved to locate its center on a trajectory formed after an inner circumferential arc having a radius of 0<r1<R/2 from the center of the melt surface and an outer circumferential arc having a radius of R/2<r2<R from a center of the melt surface are connected by a straight line, and a plasma output of the plasma torch during movement in the inner circumferential arc may be controlled to be lower than a plasma output of the plasma torch during movement in the outer circumferential arc.

According to this, the centers of two plasma torches are moved to be located on a trajectory formed after an inner circumferential arc having a radius of 0<r1<R/2 from the center of the melt surface and an outer circumferential arc having a radius of R/2<r2<R from the center of the melt surface are connected by a straight line, so that the entire melt surface can be heated while causing no interference of two plasma torches with each other. As a result, the life of the plasma torch can be extended. In addition, the plasma output is set high during movement in the outer circumferential arc, and the plasma output is set low during movement in the inner circumferential arc, so that the heat input amount in the vicinity of the edge of a mold can be made large and the heat input amount near the central part of the mold can be made small. In turn, the growth of an initial solidified shell can be suppressed, and the total amount of heat input into the melt surface decreases as compared with the case of uniform heat input. Therefore, the depth of the molten metal pool becomes shallow, and the component segregation can be reduced. As a result, an ingot having a good casting surface can be produced.

In addition, each of the plasma torches may be moved within either one range of two divided semicircles as viewed from a front of the melt surface.

According to this, each plasma torch is moved within either one range of two divided semicircles as viewed from the front of the melt surface, so that trajectories allowing for no interference of two plasma torches with each other can be ensured.

In addition, the movement may be controlled to afford a distance of R/2 or more between centers of the plasma torches.

According to this, the movement is controlled to afford a distance of R/2 or more between centers of the plasma torches, so that a distance allowing for no interference of two plasma torches with each other can be ensured.

### Advantage of the Invention

The continuous casting method of an ingot formed of titanium or a titanium alloy in the present invention can produce an ingot having a good casting surface by reducing the component segregation and can extend the torch life.

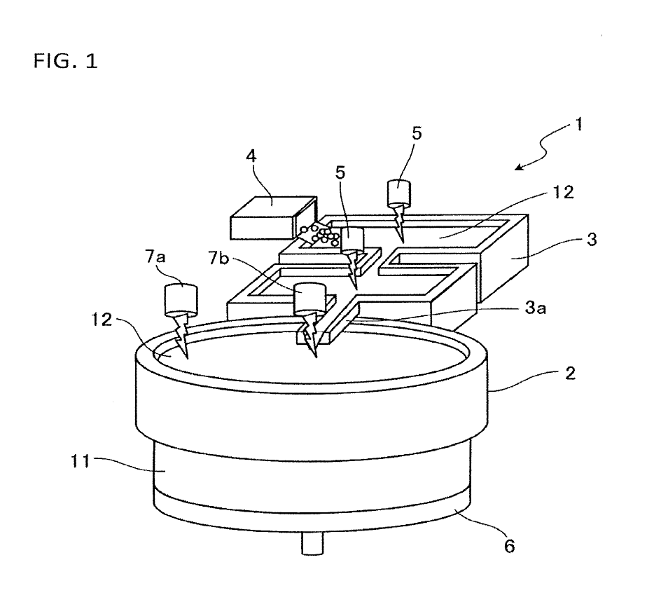

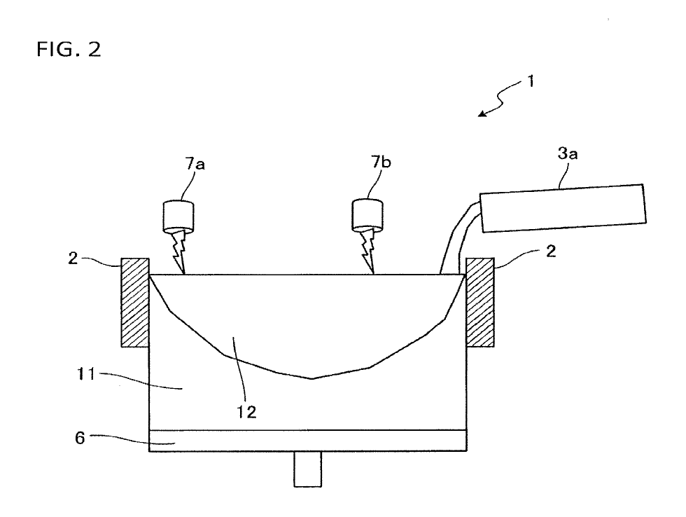

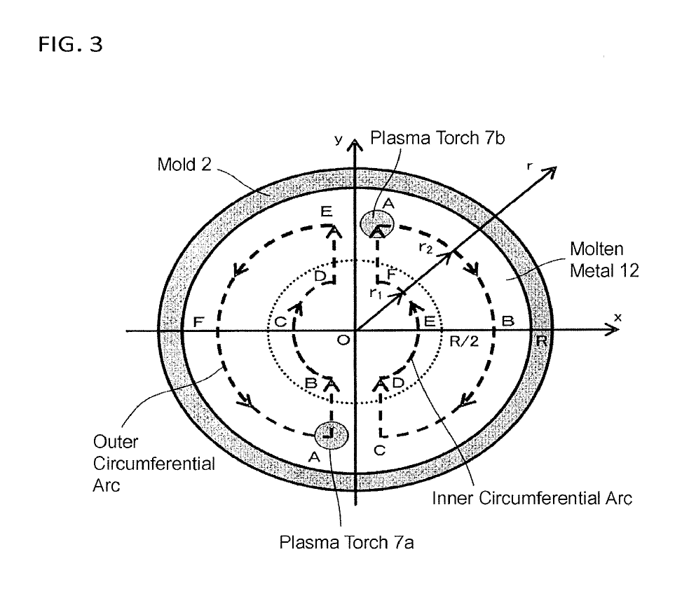

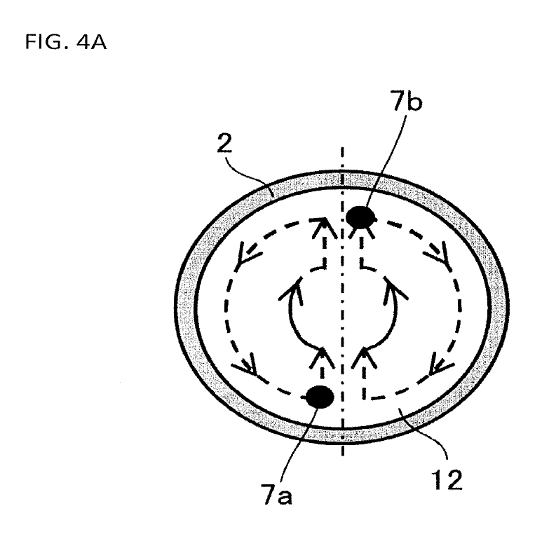

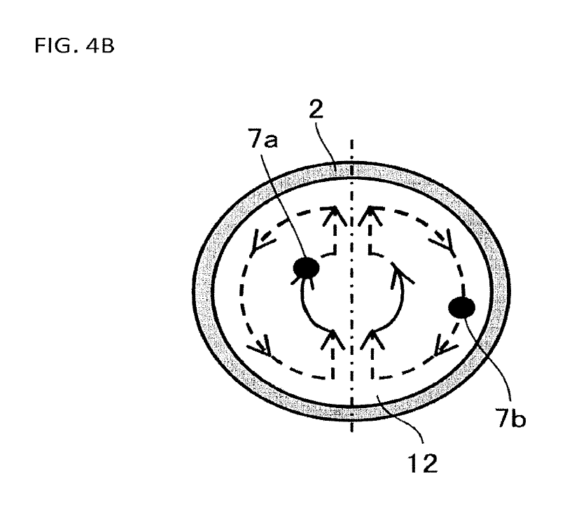

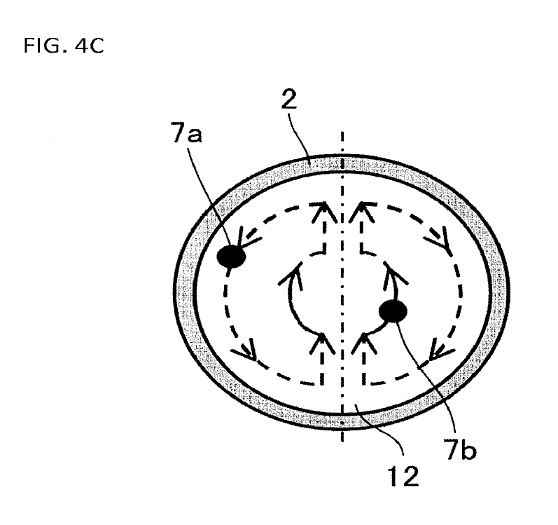

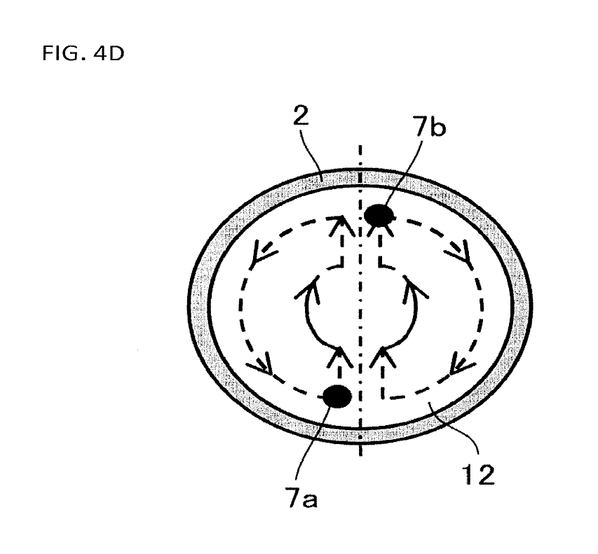

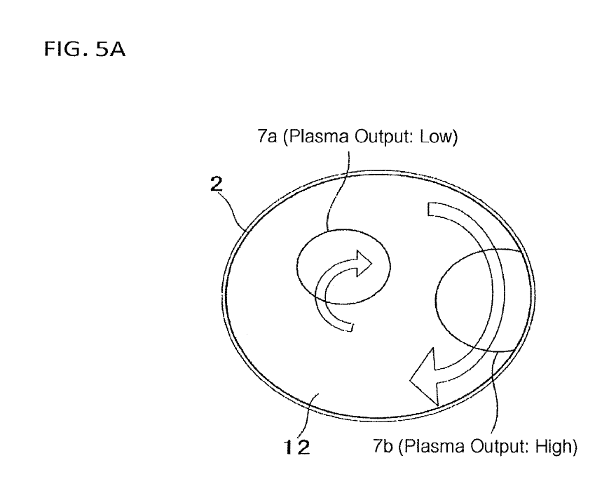

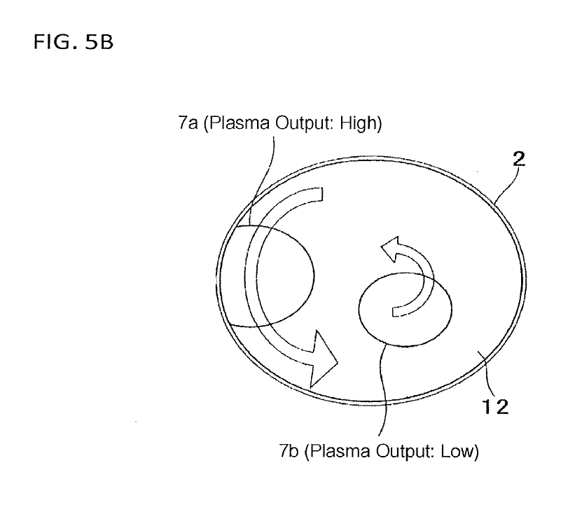

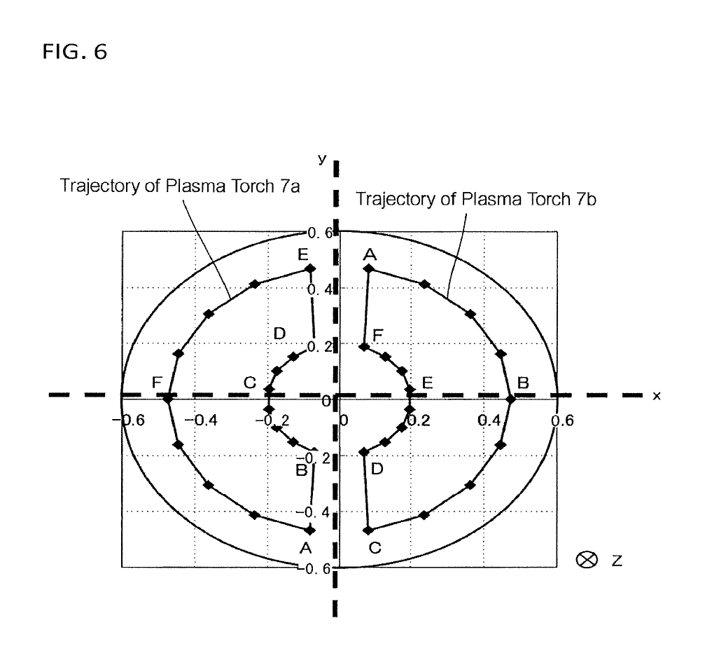

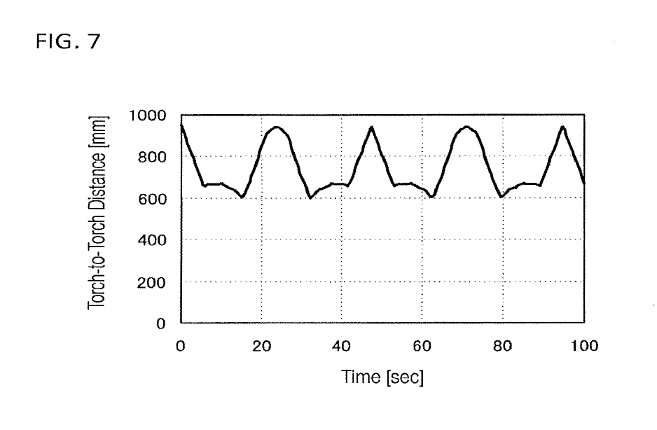

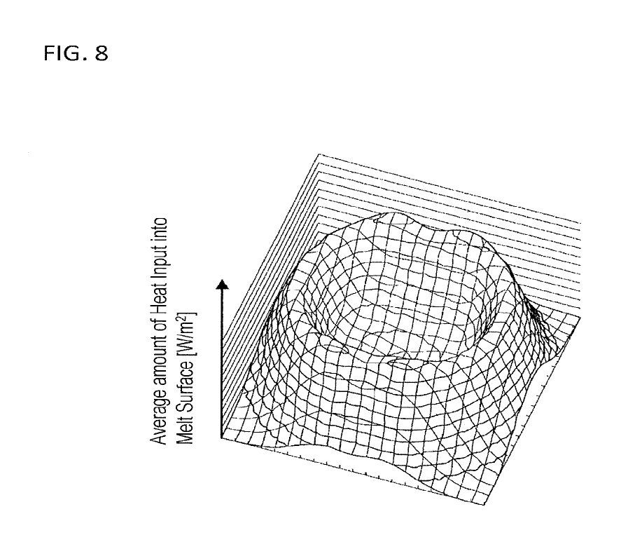

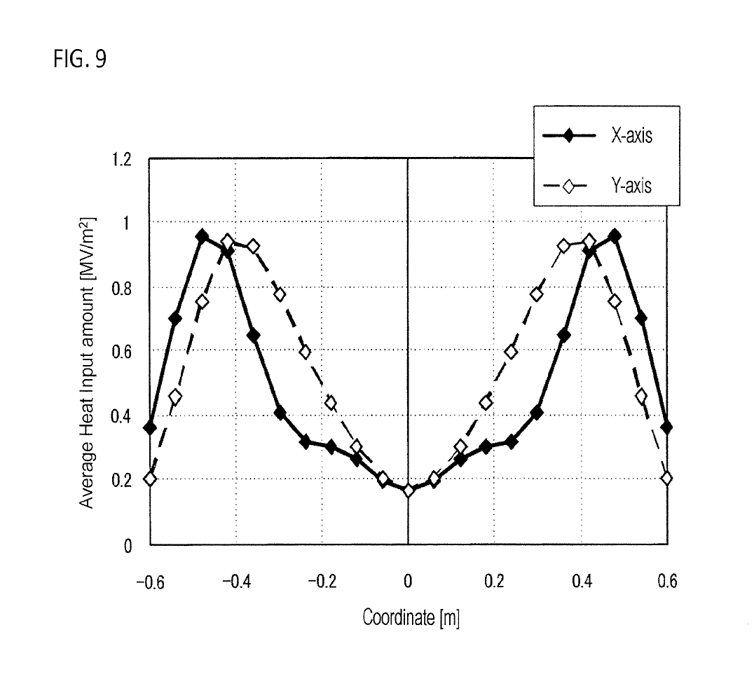

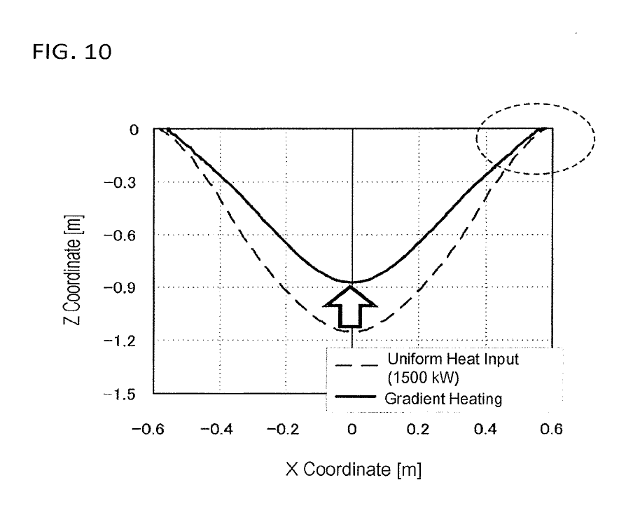

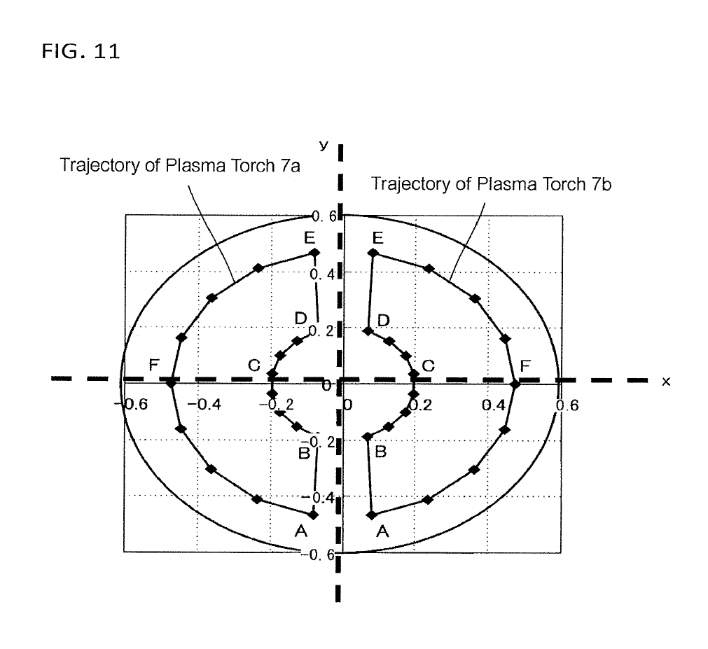

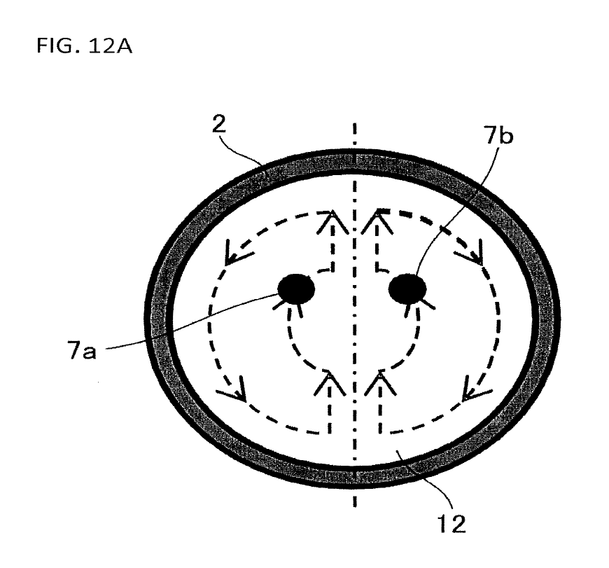

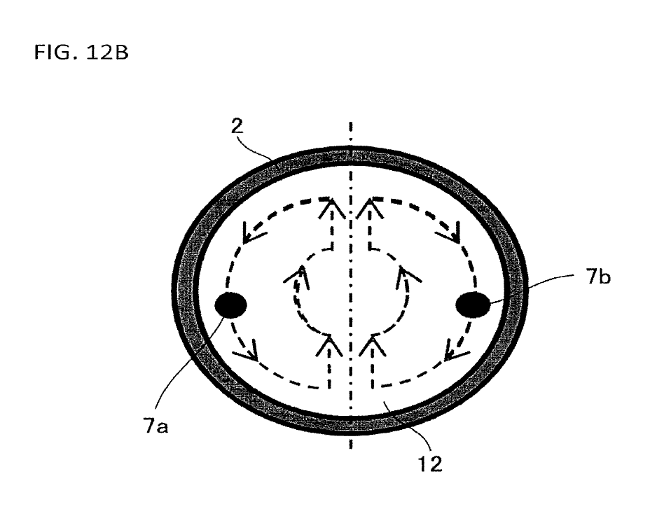

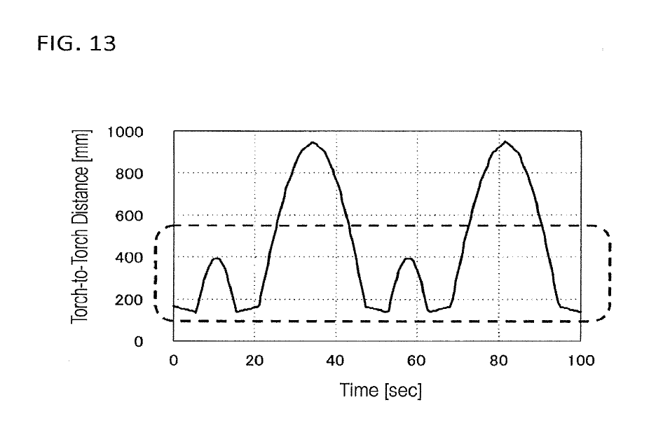

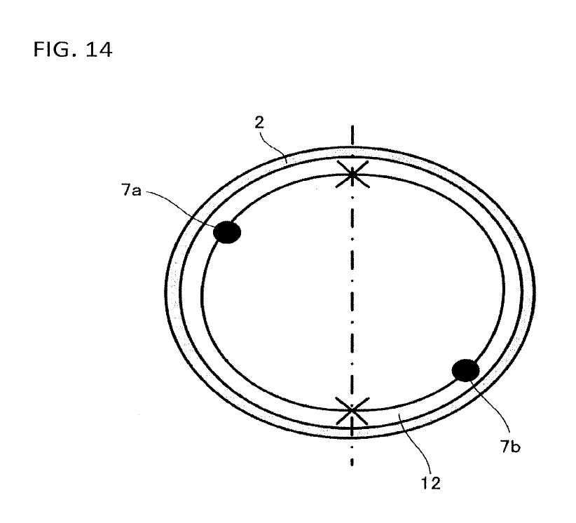

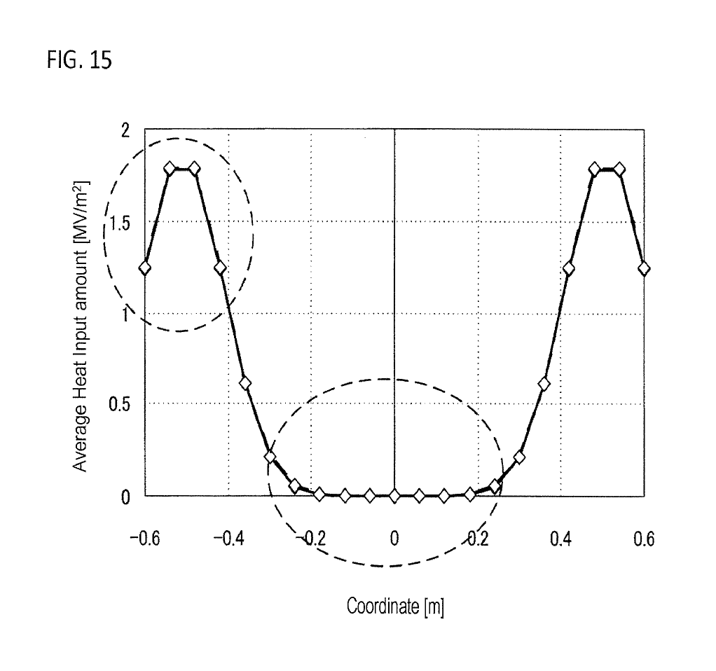

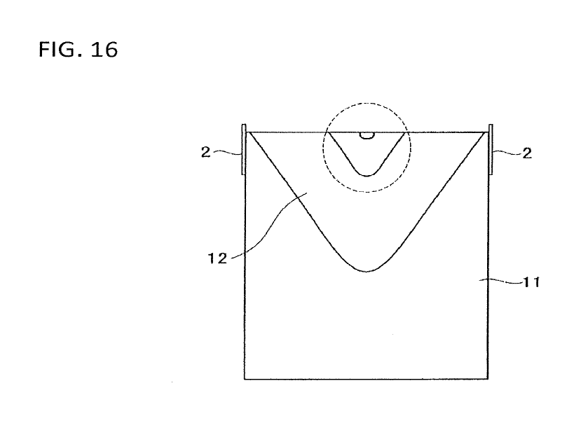

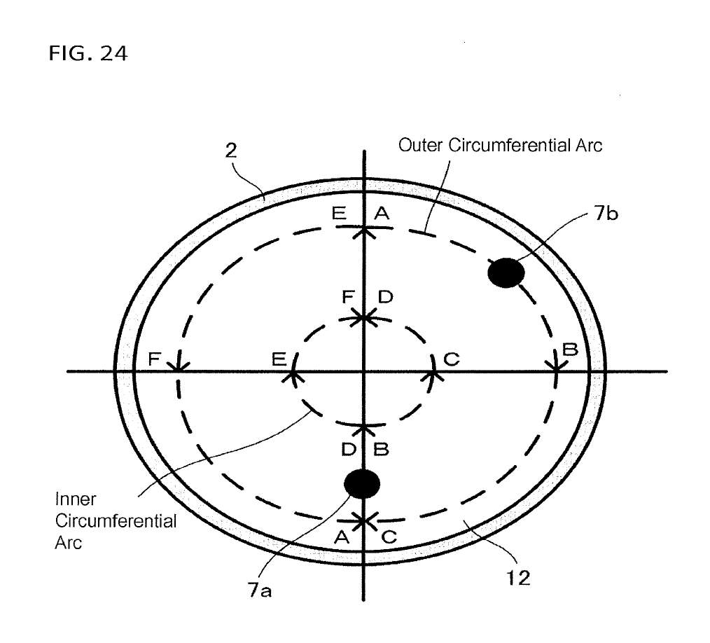

### BRIEF DESCRIPTION OF THE DRAWINGS

[FIG. 1] A perspective view of the continuous casting apparatus according to an embodiment of the present invention.

[FIG. 2] A cross-sectional view of the mold in the continuous casting apparatus according to an embodiment of the present invention.

[FIG. 3] A front view of the melt surface showing trajectories of movements of two plasma torches in the continuous casting apparatus according to an embodiment of the present invention.

[FIG. 4A] A front view of the melt surface showing trajectories of movements of two plasma torches in the continuous casting apparatus according to an embodiment of the present invention and the positional relationship therebetween.

[FIG. 4B] A front view of the melt surface showing trajectories of movements of two plasma torches in the continuous casting apparatus according to an embodiment of the present invention and the positional relationship therebetween.

[FIG. 4C] A front view of the melt surface showing trajectories of movements of two plasma torches in the continuous casting apparatus according to an embodiment of the present invention and the positional relationship therebetween.

[FIG. 4D] A front view of the melt surface showing trajectories of movements of two plasma torches in the continuous casting apparatus according to an embodiment of the present invention and the positional relationship therebetween.

[FIG. 5A] A front view of the melt surface showing the relationship between trajectories of movements of two plasma torches and plasma outputs in the continuous casting apparatus according to an embodiment of the present invention.

[FIG. 5B] A front view of the melt surface showing the relationship between trajectories of movements of two plasma torches and plasma outputs in the continuous casting apparatus according to an embodiment of the present invention.

[FIG. 6] A front view of the melt surface showing coordinates of the trajectories of movements of two plasma torches in the continuous casting apparatus according to an embodiment of the present invention.

[FIG. 7] A graph showing the torch-to-torch distance when two plasma torches in the continuous casting apparatus according to an embodiment of the present invention move along the trajectories shown in FIG. 6.

[FIG. 8] A perspective view of the melt surface showing the average amount of heat input into the melt surface when two plasma torches in the continuous casting apparatus according to an embodiment of the present invention move along the trajectories shown in FIG. 6.

[FIG. 9] A graph showing the relationship between the coordinates of the average heat input amount (time average) as viewed from the directions of xy coordinate axes and the average amount of heat input into the melt surface when two plasma torches in the continuous casting apparatus according to an embodiment of the present invention move along the trajectories shown in FIG. 6.

[FIG. 10] A graph showing the relationship between the coordinates and the pool depth in the case of performing gradient heating or uniform heat input when two plasma torches in the continuous casting apparatus according to an embodiment of the present invention move along the trajectories shown in FIG. 6.

[FIG. 11] A front view of the melt surface showing the coordinates of trajectories of movements of two plasma torches in Comparative Example 1.

[FIG. 12A] A front view of the melt surface showing trajectories of movements of two plasma torches in Comparative Example 1 and the positional relationship therebetween.

[FIG. 12B] A front view of the melt surface showing trajectories of movements of two plasma torches in Comparative Example 1 and the positional relationship therebetween.

[FIG. 13] A graph showing the torch-to-torch distance when two plasma torches in Comparative Example 1 move along the trajectories shown in FIGS. 12A and 12B.

[FIG. 14] A front view of the melt surface showing trajectories of movements of two plasma torches in Comparative Example 2 and the positional relationship therebetween.

[FIG. 15] A graph showing the relationship between the coordinates and the average amount of heat input into the melt surface when two plasma torches in Comparative Example 2 move along the trajectory shown in FIG. 14.

[FIG. 16] A cross-sectional view showing the pool depth of a molten metal pool formed inside of a mold when two plasma torches in Comparative Example 2 move along the trajectory shown in FIG. 14.

[FIG. 17] A graph showing the relationship between the total amount of heat input into the melt surface and the pool depth of a molten metal pool formed inside of a mold when uniform heat input or gradient heat input is performed in a continuous casting apparatus.

[FIG. 18] A graph showing the relationship between the average heat input amount at the edge and the amount of a shell exposed to the melt surface when uniform heat input or gradient heat input is preformed in a continuous casting apparatus.

[FIG. 19] A cross-sectional view showing the relationship between the average amount of heat input into the melt surface and the pool depth of a molten metal pool formed inside of a mold in a continuous casting apparatus when the total heat input amount is reduced and the heat input amount is concentrated in the vicinity of the edge.

[FIG. 20] A cross-sectional view showing the relationship between the average amount of heat input into the melt surface and the pool depth of a molten metal pool formed inside of a mold in a continuous casting apparatus when the total heat input amount is the same but the heat input amount near the central part is increased.

[FIG. 21] A graph showing the relationship between the heat input amount in the vicinity of the edge of a mold and the heat input amount near the central part of the mold in a continuous casting apparatus when the total heat input amount is the same.

[FIG. 22A] A front view of the melt surface showing the trajectory of the center of a plasma torch in the case of using one plasma torch.

[FIG. 22B] A graph showing the history of heat input amount at the point A in the case of using one plasma torch.

[FIG. 23A] A front view of the melt surface showing trajectories of the centers of plasma torches in the case of using two plasma torches.

[FIG. 23B] A graph showing the history of heat input amount at the point A in the case of using two plasma torches.

[FIG. 24] A front view of the melt surface showing trajectories of movements of two plasma torches in a continuous casting apparatus according to another embodiment.

### EMBODIMENTS FOR CARRYING OUT THE INVENTION

The embodiments for carrying out the continuous casting method of an ingot formed of titanium or a titanium alloy according to the present invention are described below in line with a specific example by referring to the drawings.

Those described below are merely illustrative and do not indicate application limitations of the continuous casting method of an ingot formed of titanium or a titanium alloy according to the present invention. That is, the continuous casting method of an ingot formed of titanium or a titanium alloy according to the present invention is not limited to the following embodiments, and various changes falling within the scope of claims can be made therein.

### (Configuration of Continuous Casting Apparatus)

The continuous casting apparatus of an ingot formed of titanium or a titanium alloy according to an embodiment of the present invention is a continuous casting apparatus where a molten metal obtained by plasma arc melting of titanium or a titanium alloy is poured into a bottomless mold and the molten metal is solidified and the molten metal solidified is pulled out downward, thereby continuously casting an ingot formed of titanium or a titanium alloy. The continuous casting apparatus 1 of an ingot formed of titanium or a titanium alloy for use in an embodiment of the present invention (hereinafter, simply referred to as “continuous casting apparatus”) is described based on FIGS. 1 and 2.

As shown in FIG. 1 that is a perspective view of the continuous casting apparatus for use in an embodiment of the present invention and FIG. 2 that is a cross-sectional view of the mold in the continuous casting apparatus for use in an embodiment of the present invention, the continuous casting apparatus 1 includes a mold 2, a cold hearth 3, a raw material charging device 4, a plasma torch 5, a starting block 6, and two plasma torches 7a and 7b. An inert gas atmosphere such as argon gas or helium gas is made around the continuous casting apparatus 1.

The raw material charging device 4 charges a raw material of titanium or a titanium alloy, such as sponge titanium and scrap, into the cold hearth 3. The plasma torch 5 is disposed on the upper side of the cold hearth 3 and generates a plasma arc to melt the raw material in the cold hearth 3. A molten metal 12 after the melting of raw material in the cold hearth 3 is poured by the cold hearth 3 at a predetermined flow rate into the mold 2 from a melt pouring part 3a.

The mold 2 is made of copper and is formed to be bottomless and have an opening at the top (top opening). In addition, the mold 2 is formed so as to have a circular cross-sectional shape having a diameter (φ) of 800 to 1,200 mm. Inside of at least a part of the cylindrical wall of the mold 2, a water-cooling mechanism (not shown) for cooling the mold with circulating water is provided so as to prevent damage by the high-temperature molten metal 12 poured.

The starting block 6 is moved up and down by a drive part (not shown) and can close the bottom-side opening of the mold 2. The molten metal 12 poured into the mold 2 starts to be solidified from its surface contacted with the mold 2 of a water cooling type. The starting block 6 closing the bottom-side opening part of the mold 2 is drawn downward at a predetermined speed, whereby an ingot 11 having a cylindrical shape resulting from solidification of the molten metal 12 is continuously cast while being pulled out downward.

Two plasma torches 7a and 7b are a torch generating a plasma arc and are provided on the upper side of the top-side opening of the mold 2, i.e., on the upper side of the molten metal 12 in the mold 2. The melt surface of the molten metal 12 poured into the mold 2 is irradiated with plasma arcs generated from two plasma torches 7a and 7b, whereby the molten metal 12 in the mold 2 is heated with plasma arcs. In addition, two plasma torches 7a and 7b are disposed movably in the horizontal direction.

Here, in the case of electron beam melting in a vacuum atmosphere, casting of a titanium alloy is difficult, because trace components evaporate, but in the case of plasma arc melting in an inert gas atmosphere, not only pure titanium but also a titanium alloy can be cast.

The continuous casting apparatus 1 may include a flux charging device for charging solid-phase or liquid-phase flux onto the melt surface of the molten metal 12 in the mold 2. Here, in the case of electron beam melting in a vacuum atmosphere, charging of flux into the molten metal 12 in the mold 2 is difficult, because the flux scatters. On the other hand, the plasma arc melting in an inert gas atmosphere is advantageous in that the flux can be charged into the molten metal 12 in the mold 2.

Next, the trajectories of movements of two plasma torches 7a and 7b in the continuous casting apparatus 1 for use in an embodiment of the present invention are described based on FIGS. 3 to 5A and FIG. 5B.

As shown in FIG. 3 that is a front view of the melt surface showing trajectories of movements of two plasma torches 7a and 7b, assuming that when the molten metal 12 is viewed from the front of the melt surface, the center O of the molten metal 12 in the mold 2 is an origin and the melt surface perpendicular to the central axis of the molten metal 12 is an xy plane, two plasma torches 7a and 7b are controlled so that respective centers can move in the following ranges:

Range of plasma torch 7a: the range of x<0 (left semicircle in FIG. 3)

Range of plasma torch 7b: the range of x>0 (right semicircle in FIG. 3)

When the radius of the molten metal 12 (i.e., ingot 11) is assumed to be R, the plasma torches 7a and 7b are controlled so that respective centers can trace the following trajectories during movement in the direction of A→B→C→D→E→F:

Inner circumferential arc having a radius of 0<r1<R/2: B→C→D for the plasma torch 7a, and D→E→F for the plasma torch 7b

Outer circumferential arc having a radius of R/2<r2<R: E→F→A for the plasma torch 7a, and A→B→C for the plasma torch 7b

Straight line connecting two arcs, i.e., inner circumferential arc and outer circumferential arc: A→B and D→E for the plasma torch 7a, and C→D and F→A for the plasma torch 7b

That is, the plasma torch 7a is controlled so that its center can trace the following trajectories:

A→B: straight line connecting two arcs, i.e., inner circumferential arc and outer circumferential arc

B→C→D: inner circumferential arc

D→E: straight line connecting two arcs, i.e., inner circumferential arc and outer circumferential arc

E→F→A: outer circumferential arc

In addition, the plasma torch 7b is controlled so that its center can trace the following trajectories:

A→B→C: outer circumferential arc

C→D: straight line connecting two arcs, i.e., inner circumferential arc and outer circumferential arc

D→E→F: inner circumferential arc

F→A: straight line connecting two arcs, i.e., inner circumferential arc and outer circumferential arc

As shown in FIGS. 5A and 5B that are front views of the melt surface each showing the relationship between trajectories of movements of two plasma torches 7a and 7b and plasma outputs, the plasma torches 7a and 7b are controlled to give a high torch output when each center moves in the outer circumferential arc and give a low torch output when each center moves in the inner circumferential arc. This can make the heat input amount in the vicinity of the edge of the mold 2 large and make the heat input amount near the central part small. As a result, the growth of an initial solidified shell can be suppressed. Furthermore, the total amount of heat input into the melt surface decreases as compared with uniform heat input and therefore, the depth of the molten metal pool becomes shallow, so that the component segregation can be reduced.

As shown in FIGS. 4A to 4D that are front views of the melt surface each showing trajectories of movements of two plasma torches 7a and 7b and the positional relationship therebetween, respective centers of the plasma torches 7a and 7b move in the direction of A→B→C→D→E→F. It is found that thanks to such movements, the plasma torches 7a and 7b can keep a distance of R/2 or more between torch centers (hereinafter, simply referred to as “torch-to-torch distance”). It is also found that when either one of the plasma torches 7a and 7b moves in the inner circumferential arc, the other plasma torch 7a or 7b is controlled to be located on the outer circumferential arc.

Next, the simulation results of component segregation that is caused when an ingot is continuously cast using the continuous casting apparatus 1 for use in an embodiment of the present invention are discussed by referring to FIGS. 6 to 10.

In the simulation according to an embodiment of the present invention, the material of the ingot was Ti-6Al-4V, the size of the mold 2 (i.e., the radius R of the melt surface of the molten metal 12) was 600 mm, and the amount of the raw material melted was 1.3 ton/hour. In addition, as viewed from the front of the melt surface (i.e., from the top-side opening of the mold 2), the coordinates of trajectories of movements of two plasma torches 7a and 7b are as shown in FIG. 6 when expressed on xy coordinate axes with the origin being fixed at the center of the melt surface. Here, in the trajectories of the plasma torches 7a and 7b shown in FIG. 6, the radius r1 of the inner circumferential arc is 200 mm, and the radius r2 of the outer circumferential arc is 450 mm. Furthermore, each of the plasma torches 7a and 7b moves in the direction of A→B→C→D→E→F, and the moving speed is 50 mm/sec. In each of the plasma torches 7a and 7b, the plasma output during movement in the inner circumferential arc is 200 kW, and the plasma output during movement in the outer circumferential arc is 750 kW.

It is found from the graph showing the history of torch-to-torch distance in FIG. 7 that the torch-to-torch distance of the plasma torches 7a and 7b moving based on the trajectories shown in FIG. 6 is 600 mm or more. That is, it is found that in this simulation, the torch-to-torch distance of the plasma torches 7a and 7b can ensure a distance of R/2 or more, in which R is radius of melt surface of molten metal 12.

In addition, as seen from FIG. 8 showing the average amount of heat input into the melt surface (time average) of the molten metal 12 during movements of plasma torches 7a and 7b based on the trajectories shown in FIG. 6, and FIG. 9 showing the average heat input amount (time average) as viewed from the x-axis and y-axis directions (see, FIG. 6) during movements of plasma torches 7a and 7b based on the trajectories shown in FIG. 6, gradient heating with a high heat input amount in the vicinity of the edge of the mold 2 and a low heat input amount in the central part of the mold 2 can be realized.

Furthermore, the results of a simulation of measuring the pool depth of the molten metal pool (i.e., the value of z coordinate relative to x coordinate when y=0) formed inside of the mold 2, which is performed for a case where while moving plasma torches 7a and 7b based on the trajectories shown in FIG. 6, gradient heating is conducted by setting the plasma output during movement in the inner circumferential arc to 200 kW and the plasma output during movement in the outer circumferential arc to 750 kW as described above and for a case where uniform heat input with a constant plasma output of 1,500 kW is conducted, are shown in FIG. 10. As shown in FIG. 10, the pool depth in the case of gradient heating is 873 mm, and the pool depth in the case of uniform heat input is 1,150 mm, revealing that the pool depth is reduced when gradient heating is conducted. In addition, in the case of gradient heating and in the case of uniform heat input, a pool depth is obtained in the vicinity of the edge of the mold 2 (near 0.6 m and near −0.6 m of the x coordinate axis, surrounded by a dashed line shown in FIG. 10) and therefore, it is found that melting can proceed up to the vicinity of the edge of the mold 2 and the growth of a shell can be suppressed.

Next, in comparison with the above-described continuous casting apparatus 1 for use in an embodiment of the present invention, the simulation results of Comparative Example 1 where two plasma torches are moved on trajectories different from the trajectories shown in FIG. 6, are described based on FIGS. 11 to 13.

In the simulation of Comparative Example 1, the conditions regarding the material of the ingot, the size of the mold 2, and the amount of the raw material melted are the same as in the above-described simulation according to an embodiment of the present invention, and only the trajectories of two plasma torches are changed. In addition, as viewed from the front of the melt surface (i.e., from the top-side opening of the mold 2), the coordinates of trajectories of movements of two plasma torches 7a and 7b are as shown in FIG. 11 when expressed on xy coordinate axes with the origin being fixed at the center of the melt surface. Here, in the trajectories of the plasma torches 7a and 7b, the radius r1 of the inner circumferential arc is 200 mm, and the radius r2 of the outer circumferential arc is 450 mm.

Furthermore, in the case where each of the plasma torches 7a and 7b moves in the direction of A→B→C→D→E→F and the moving speed is 50 mm/sec, in Comparative Example 1, two plasma torches 7a and 7b move based on trajectories and positional relationship shown in FIGS. 12A and 12B.

As shown in FIGS. 12A and 12B, it is found that two plasma torches 7a and 7b are simultaneously located on the inner circumferential arc or outer circumferential arc. In addition, as shown in FIG. 13, the torch-to-torch distance of plasma torches 7a and 7b moving based on the trajectories shown in FIGS. 11, 12A and 12B becomes R/2 (300 mm) or less, in which R is radius of melt surface of molten metal 12, when both of two plasma torches 7a and 7b are located on the inner circumferential trajectory (the time when the torch-to-torch distance is included in the range surrounded by a dashed line shown in FIG. 13). Thus, it is found that plasma torches 7a and 7b may interfere with each other.

Next, in comparison with the above-described continuous casting apparatus 1 for use in an embodiment of the present invention, the simulation results of Comparative Example 2 where two plasma torches are moved on trajectories different from the trajectories shown in FIG. 6, are described based on FIGS. 14 to 16.

In the simulation of Comparative Example 2, the conditions regarding the material of the ingot, the size of the mold 2, and the amount of the raw material melted were the same as in the above-described simulation according to an embodiment of the present invention, and only the trajectories and plasma outputs of two plasma torches were changed. In addition, as viewed from the front of the melt surface (i.e., from the top-side opening of the mold 2), the trajectories of movements of two plasma torches 7a and 7b are as shown in FIG. 14. As shown in FIG. 14, two plasma torches 7a and 7b move only in the outer circumferential arc and do not move in the inner circumferential arc. That is, two plasma torches 7a and 7b heat only the outer circumferential arc but do not heat the inner circumferential arc. Here, in the trajectories of plasma torches 7a and 7b, the radius r2 of the outer circumferential arc is 525 mm.

The moving speed of each of the plasma torches 7a and 7b is 50 mm/sec. In addition, the plasma output of each of the plasma torches 7a and 7b is constantly 1,000 kW.

As seen from FIG. 15 showing the average amount of heat input into the melt surface (time average) of the molten metal 12 during movements of plasma torches 7a and 7b based on the trajectory shown in FIG. 14, heating is excessively concentrated in the vicinity of the edge of the mold 2 and the heat input amount in the central part of the mold 2 is zero, as shown by dashed lines in the Figure. The coordinates in FIG. 15 are obtained by, similarly to FIGS. 6 and 11, expressing the coordinates of trajectories of movements of two plasma torches 7a and 7b shown in FIG. 14 on xy coordinate axes with the origin being fixed at the center of the melt surface, as viewed from the front of the melt surface (i.e., from the top-side opening of the mold 2).

Furthermore, the results of a simulation of measuring the pool depth of the molten metal pool formed inside of the mold 2, with the heat input amount in the mold 2 being shown by a cross-sectional view, which is performed for a case where while moving plasma torches 7a and 7b based on the trajectory shown in FIG. 14, uniform heat input is conducted by setting the plasma output during movement in the outer circumferential arc to be constantly 1,000 kW as described above, are shown in FIG. 16. It is found that, as shown by a dashed line in FIG. 16, the heat input amount lacks in the central part of the mold 2 to cause solidification.

As described above, in the continuous casting apparatus of an ingot formed of titanium or a titanium alloy for use in an embodiment of the present invention, two plasma torches 7a and 7b are used, so that the movement distance of each plasma torch 7a or 7b can be shortened and reduction in the ingot temperature can be suppressed. In addition, each of two plasma torches 7a and 7b is moved to be located either on the upper side in the vicinity of the edge of a mold 2 or on the upper side near the central part of the mold 2, so that the entire melt surface can be heated without causing interference of two plasma torches 7a and 7b with each other.

Furthermore, the centers of two plasma torches 7a and 7b are moved to be located on trajectories formed after an inner circumferential arc having a radius of 0<r1<R/2 from the center of the melt surface and an outer circumferential arc having a radius of R/2<r2<R from the center of the melt surface are connected by a straight line, so that the entire melt surface can be heated without causing interference of two plasma torches 7a and 7b with each other. As a result, the life of the torch can be extended. In addition, the plasma output is set high when the plasma torches 7a and 7b move in the outer circumferential arc, and the plasma output is set low during movement in the inner circumferential arc, so that the heat input amount in the vicinity of the edge of a mold 2 can be made large and the heat input amount near the central part of the mold 2 can be made small. In turn, the growth of an initial solidified shell can be suppressed, and the total amount of heat input into the melt surface decreases as compared with uniform heat input. Therefore, the depth of the molten metal pool becomes shallow, and the component segregation can be reduced.

As a result, in the continuous casting method of an ingot formed of titanium or a titanium alloy according to an embodiment of the present invention, an ingot 11 having a good casting surface can be produced by reducing the component segregation and the lives of plasma torches 7a and 7b can be extended by causing no interference of plasma torches 7a and 7b with each other.

In the foregoing pages, the present invention has been described with reference to preferred embodiments thereof, but the present invention is not limited to these embodiments, and various changes falling within the scope of claims can be made therein.

In the above-described continuous casting method of an ingot formed of titanium or a titanium alloy according to an embodiment of the present invention, with respect to trajectories of movements of two plasma torches 7a and 7b, assuming that when the molten metal 12 is viewed from the front of the melt surface, the center of the molten metal 12 in the mold 2 is an origin and the melt surface perpendicular to the central axis of the molten metal 12 is an xy plane, two plasma torches 7a and 7b are controlled so that each center can move in the range of x<0 or x>0, but the present invention is not limited thereto.

For example, as shown in FIG. 24, when the radius of the molten metal 12 (i.e., ingot 11) is assumed to be R, the plasma torches 7a and 7b may be controlled so that respective centers can trace the following trajectories during movement in the direction of A→B→C→D→E→F:

Inner circumferential arc having a radius of 0<r1<R/2: B→C→D for the plasma torch 7a, and D→E→F for the plasma torch 7b

Outer circumferential arc having a radius of R/2<r2<R: E→F→A for the plasma torch 7a, and A→B→C for the plasma torch 7b

Straight line connecting two arcs, i.e., inner circumferential arc and outer circumferential arc: A→B and D→E for the plasma torch 7a, and C→D and F→A for the plasma torch 7b

That is, in FIG. 24, the plasma torches 7a and 7b are controlled so that respective centers can trace the following trajectories.

For plasma torch 7a:

A→B: straight line connecting two arcs, i.e., inner circumferential arc and outer circumferential arc

B→C→D: inner circumferential arc (range of x>0)

D→F: straight line connecting two arcs, i.e., inner circumferential arc and outer circumferential arc

E→F→A: outer circumferential arc (range of x<0)

For plasma torch 7b:

A→B→C: outer circumferential arc (range of x>0)

C→D: straight line connecting two arcs, i.e., inner circumferential arc and outer circumferential arc

D→E→F: inner circumferential arc (range of x<0)

F→A: straight line connecting two arcs, i.e., inner circumferential arc and outer circumferential arc

Also in such a case, the centers of two plasma torches 7a and 7b are moved to be located on trajectories formed after an inner circumferential arc having a radius of 0<r1<R/2 from the center of the melt surface and an outer circumferential arc having a radius of R/2<r2<R from the center of the melt surface are connected by a straight line, so that the entire melt surface can be heated without causing interference of two plasma torches 7a and 7b with each other.

Any other trajectories may be employed as long as the entire melt surface can be heated without causing interference of two plasma torches 7a and 7b with each other.

In the above-described continuous casting method of an ingot formed of titanium or a titanium alloy according to an embodiment of the present invention, two plasma torches 7a and 7b are used as the plasma torch, but the present invention is not limited thereto. Using a plurality of plasma torches, their trajectories may be ensured so that the entire melt surface can be heated without causing interference with each other.

### DESCRIPTION OF REFERENCE NUMERALS AND SIGNS

1: Continuous casting apparatus

2: Mold

7a: Plasma torch

7b: Plasma torch

11: Ingot

12: Molten metal

1: A method of continuously casting an ingot formed of titanium or a titanium alloy, comprising:
pouring a molten metal prepared by melting titanium or a titanium alloy into a top opening of a bottomless mold with a circular cross-sectional shape, whereby the molten metal may be solidified in the bottomless mold;
pulling the solidified molten metal in the mold downward to remove the solidified molten metal from the mold;
disposing a plurality of plasma torches on an upper side of molten metal in the mold such that centers of the plurality of plasma torches are located directly vertically above the molten metal in the mold;
operating the plasma torches to generate plasma arcs that heat the molten metal in the mold; and
moving each of the plurality of plasma torches, while operated to generate the plasma arcs, in a horizontal direction above a melt surface of the molten metal in the mold, along a trajectory located directly vertically above the molten metal in the mold, while keeping a mutual distance between the respective plasma torches such that the plasma torches do not interfere with each other.

2: The continuous casting method as claimed in claim 1, wherein
a number of the plasma torches is 2, and
the plasma torches are moved, during the step of moving the plasma torches, such that when one plasma torch is located directly vertically above the vicinity of an edge of the mold, the other plasma torch is located directly vertically above a central part of the mold.

3: The continuous casting method as claimed in claim 2, wherein
assuming that a radius of the melt surface is R, the plasma torch is moved, during the step of moving the plasma torches, to locate its center on a trajectory according to an inner circumferential arc having a radius of 0<r1<R/2 from a center of the melt surface and an outer circumferential arc having a radius of R/2<r2<R from the center of the melt surface, which inner and outer circumferential arcs are connected by a straight line, and
a plasma output of each plasma torch during movement according to the inner circumferential arc is controlled to be lower than a plasma output of the respective plasma torch during movement according to the outer circumferential arc.

4: The continuous casting method as claimed in claim 3, wherein each of the plasma torches is moved, during the step of moving the plasma torches, within a range of either one of two divided semicircles, as viewed from above the melt surface.

5: The continuous casting method as claimed in claim 3, wherein a distance of R/2 or more is maintained between the centers of the plasma torches during the step of moving the plasma torches.

6: The continuous casting method as claimed in claim 4, wherein a distance of R/2 or more is maintained between the centers of the plasma torches during the step of moving the plasma torches.
